(19) United States
(12) Patent Application Publication
(10) Pub. No.: US 2025/0348433 A1
(43) Pub. Date: Nov. 13, 2025

(54) STORAGE DEVICE WITH CACHE AND METHOD FOR OPERATING

(71) Applicant: Samsung Electronics Co., Ltd., Suwon-si (KR)

(72) Inventors: Marie Mai NGUYEN, Pittsburgh, PA (US); Rekha PITCHUMANI, Oak Hill, VA (US); Sai Prahladh PADMANABHAN, San Jose, CA (US); Jingoo HAN, San Jose, CA (US); Zongwang LI, Dublin, CA (US); Yang Seok KI, Palo Alto, CA (US)

(21) Appl. No.: 19/007,356

(22) Filed: Dec. 31, 2024

Related U.S. Application Data
(60) Provisional application No. 63/644,861, filed on May 9, 2024.

(51) Int. Cl. G06F 12/0891; G06F 12/0862; G06F 12/126

(52) U.S. Cl. CPC G06F 12/0891; G06F 12/0862; G06F 12/126

(57) ABSTRACT

A storage device with cache and a method for operating a storage device. In some embodiments, a method includes receiving, by a storage device including a cache and nonvolatile memory, a command to place a lock on a first data unit stored in the cache; and selecting a second data unit for eviction, based on a combination of an eviction algorithm and the command.

### CROSS-REFERENCE TO RELATED APPLICATION(S)

The present application claims priority to and the benefit of U.S. Provisional Application No. 63/644,861, filed May 9, 2024, entitled “SYSTEMS AND METHODS TO ENHANCE COMPUTE EXPRESS LINK (CXL) SOLID STATE DRIVE (SSD) PREFETCH”, the entire content of which is incorporated herein by reference.

### FIELD

One or more aspects of embodiments according to the present disclosure relate to storage devices, and more particularly to a storage device with a cache.

### BACKGROUND

A computing system may include a host connected to a storage device, which may provide persistent storage for the host. The host may include a processor and memory. In operation, the host may store data in the storage device, and read, or retrieve, data from the storage device.

It is with respect to this general technical environment that aspects of the present disclosure are related.

### SUMMARY

According to an embodiment of the present disclosure, there is provided a method, including: receiving, by a storage device including a cache and nonvolatile memory, a command to place a lock on a first data unit stored in the cache; and selecting a second data unit for eviction, based on a combination of an eviction algorithm and the command.

In some embodiments, the selecting of the second data unit for eviction includes: performing a first iteration of the eviction algorithm, the first iteration selecting the first data unit; and based on the command, performing a second iteration of the eviction algorithm, the second iteration selecting the second data unit for eviction.

In some embodiments, the selecting of the second data unit for eviction includes selecting, by the eviction algorithm, the second data unit from a set of data units determined based on the command.

In some embodiments, the first data unit is excluded from the set of data units based on the command.

In some embodiments: the eviction algorithm targets a data unit characteristic, the first data unit has a first value of the data unit characteristic, the second data unit has a second value of the data unit characteristic, the algorithm is configured to select the first data unit based on the first value and the second value, and the second data unit is selected for eviction based on the command.

In some embodiments, the data unit characteristic is based on recency of usage.

In some embodiments: the eviction algorithm ranks a plurality of data units, including the first data unit and the second data unit, according to the data unit characteristic, and the eviction algorithm selects the second data unit based on the second data unit being a highest-ranked data unit that is not locked.

In some embodiments, the method further includes: receiving, by the storage device, a command to release the lock on the first data unit; determining that a cache eviction is needed; and evicting the first data unit.

In some embodiments, the method further includes: receiving a prefetch command for a third data unit; determining that the third data unit is absent from the cache; and storing the prefetch command in a prefetch queue, the storing of the prefetch command in the prefetch queue being based on the determining that the third data unit is absent from the cache.

In some embodiments, the storing of the prefetch command in the prefetch queue is further based on determining that a prefetch command for the third data unit is absent from the prefetch queue.

In some embodiments, the method further includes: receiving, by the storage device, a cache access sequence, the cache access sequence including a prefetch command for a third data unit and a command to place a lock on the third data unit.

In some embodiments, the method further includes performing the prefetch command for the third data unit based on the command to place the lock on the third data unit.

According to an embodiment of the present disclosure, there is provided a storage device, including: nonvolatile memory; a processing circuit; and a cache, the processing circuit being configured to receive a command to place a lock on a first data unit stored in the cache; and select a second data unit for eviction, based on a combination of an eviction algorithm and the command.

In some embodiments, the selecting of the second data unit for eviction includes: performing a first iteration of the eviction algorithm, the first iteration selecting the first data unit; and based on the command, performing a second iteration of the eviction algorithm, the second iteration selecting the second data unit for eviction.

In some embodiments, the selecting of the second data unit for eviction includes selecting, by the eviction algorithm, the second data unit from a set of data units determined based on the command.

In some embodiments, the first data unit is excluded from the set of data units based on the command.

In some embodiments: the eviction algorithm targets a data unit characteristic, the first data unit has a first value of the data unit characteristic, the second data unit has a second value of the data unit characteristic, the algorithm is configured to select the first data unit based on the first value and the second value, and the second data unit is selected for eviction based on the command.

In some embodiments: the eviction algorithm ranks a plurality of data units, including the first data unit and the second data unit, according to the data unit characteristic, and the eviction algorithm selects the second data unit based on the second data unit being a highest-ranked data unit that is not locked.

According to an embodiment of the present disclosure, there is provided a storage device, including: nonvolatile memory; means for processing; and a cache, the means for processing being configured to receive a command to place a lock on a first data unit stored in the cache; and select a second data unit for eviction, based on a combination of an eviction algorithm and the command.

In some embodiments, the selecting of the second data unit for eviction includes: performing a first iteration of the eviction algorithm, the first iteration selecting the first data unit; and based on the command, performing a second iteration of the eviction algorithm, the second iteration selecting the second data unit for eviction.

### BRIEF DESCRIPTION OF THE DRAWINGS

These and other features and advantages of the present disclosure will be appreciated and understood with reference to the specification, claims, and appended drawings wherein:

FIG. 1A is a block diagram of a host and a storage device, according to an embodiment of the present disclosure;

FIG. 1B is a system level block diagram, according to an embodiment of the present disclosure;

FIG. 1C is a block diagram of a storage device, according to an embodiment of the present disclosure;

FIG. 1D is a block diagram of a storage device with a cache and a buffer, according to an embodiment of the present disclosure;

FIG. 2A is a diagram of allocated and free memory in a storage device, according to an embodiment of the present disclosure;

FIG. 2B is a block diagram showing aspects of a storage device and host functionality, according to an embodiment of the present disclosure;

FIG. 2C is a block diagram showing aspects of a storage device and host functionality, according to an embodiment of the present disclosure;

FIG. 2D is a flowchart of an eviction process (e.g., a process for transitioning a data unit to a backed state), according to an embodiment of the present disclosure;

FIG. 2E is a flow chart of a method for selecting a data unit for eviction (e.g., a method for selecting a data unit for transitioning to a backed state), according to an embodiment of the present disclosure;

FIG. 3A shows a sequence of instructions including a set of cache access instructions, according to an embodiment of the present disclosure;

FIG. 3B shows a memory graph, according to an embodiment of the present disclosure; and

FIG. 4 is a flow chart of a method, according to an embodiment of the present disclosure.

### DETAILED DESCRIPTION

The detailed description set forth below in connection with the appended drawings is intended as a description of exemplary embodiments of a storage device with a cache provided in accordance with the present disclosure and is not intended to represent the only forms in which the present disclosure may be constructed or utilized. The description sets forth the features of the present disclosure in connection with the illustrated embodiments. It is to be understood, however, that the same or equivalent functions and structures may be accomplished by different embodiments that are also intended to be encompassed within the scope of the disclosure. As denoted elsewhere herein, like element numbers are intended to indicate like elements or features.

A computing system may include (i) a host, or “host device”, which may include a host processor and host memory, and (ii) a storage device, which may be part of (e.g., in a shared enclosure with) the host, or connected to the host. In operation, the host may perform data processing operations (e.g., neural network inference operations) on data stored in the host memory, and save the results of such processing operations to the host memory. New data may be read periodically from the storage device into the host memory, for processing, and the results of the data processing may periodically be stored, from the host memory, into the storage device. As used herein, a “storage device” is a device for storing data. The storage device may include volatile memory or nonvolatile memory (or both), and it may present itself to the host as volatile memory, or as nonvolatile memory, or as a combination of volatile memory and nonvolatile memory.

The storage device may include nonvolatile memory, a storage controller, a cache, and a buffer. The buffer may be used, e.g., to store write commands pending command completion, making it possible for the storage device to accept additional commands before a write command has been completed. The cache may make it possible (i) for data to be read repeatedly from the storage device without the data being read repeatedly from the nonvolatile memory, and (ii) for data to be modified in the cache (without necessarily or immediately also being modified in the nonvolatile memory).

In operation, a situation that may be referred to as “cache pollution” may occur as follows. An application running on the host, anticipating a need for a first set of data (which may be referred to herein as a first “data unit”), may send, to the storage device, a first user demand prefetch, which may be a command, to the storage device, to read the first data unit into the cache. The first data unit may already be in the cache (having previously been read from the nonvolatile memory into the cache), and, accordingly, the storage device may not act on the first user demand prefetch. For example, the cache controller may receive the user demand prefetch command, determine that the first data unit is already in the cache, and, therefore, not read the first data unit from the nonvolatile memory into the cache.

The operation of forwarding the user demand prefetch command to the cache controller and determining that the first data unit is already in the cache may consume internal bandwidth, however, in the storage device. For example, sending a redundant request prefetch may waste internal bandwidth for all cache controller-related checks and also waste bandwidth at the storage device, for the issuing of a read from the storage to the cache. The application may then, before having read the first data unit from the cache, issue a second user demand prefetch for a second data unit, which will be needed, by the application, after it has processed the first data unit. In response to the second user demand prefetch, the storage device may (i) determine that the cache is full and that a cache eviction is needed to make room for the second data unit, (ii) determine that the first data unit (which may be older than other data units in the cache) is the best candidate for eviction, and evict the first data unit, and (iii) read the second data unit into the cache.

This sequence may result in the first data unit not being available in the cache when subsequently needed by the application. As a result, the first data unit may be read into the cache again, from the nonvolatile memory; this additional read operation may degrade the performance and power efficiency of the storage device. As such, in some embodiments, a “pin” command for a data unit may be used to signal, by the application, to the storage device, that the data unit is not to be evicted from the cache until a corresponding “unpin” command has been received by the storage device. In such an embodiment, when the application sends, to the storage device, a prefetch command for a data unit that will be needed, by the application, for a future calculation, it may also (e.g., first) send a pin command to the storage device, to prevent the cached first data unit from being evicted before it has been used by the application.

In some embodiments, the storage device includes a prefetch controller and a cache controller. Each of these two entities may be implemented in firmware running in the storage controller, or either or both of these two entities may be implemented in dedicated or special-purpose hardware (e.g., a special-purpose or dedicated processing circuit). In some embodiments, the prefetch controller may not monitor the contents of the cache, and, as such, the prefetch controller may simply forward user demand prefetch commands to the cache controller for processing. This may consume internal bandwidth in the storage device, as mentioned above. In some other embodiments, therefore, a request module, which may be part of the prefetch controller, may process (e.g., forward to the cache controller) each user demand prefetch command for a data unit only when the command is not redundant, e.g., only when (i) a user demand prefetch command for the same data unit is not already in the prefetch queue and (ii) the data unit is not already in the cache.

In some embodiments, the storage device may schedule the performing of user demand prefetches based on information, e.g., a cache access sequence, that it has received from the application. The cache access sequence may include a sequence of cache access instructions, including read, write, prefetch, pin, and unpin. The storage device may use the cache access sequence to determine when to perform various operations, so as to make effective use of the cache. For example, if the sequence includes a prefetch command for a first data unit, followed by commands for other data units, followed by a pin command for the first data unit, the storage device may delay the performing of the prefetch of the first data unit until just before or just after the pin command for the first data unit. The delaying of the prefetch of the first data unit until just before or just after the pin command for the first data unit may allow other data to remain in the cache longer, and thereby reduce the risk of a cache miss. The delaying of the prefetch of the first data unit until just before or just after the pin command for the first data unit may also allow the storage device to perform the intervening instructions sooner, which may result in an improvement in system performance.

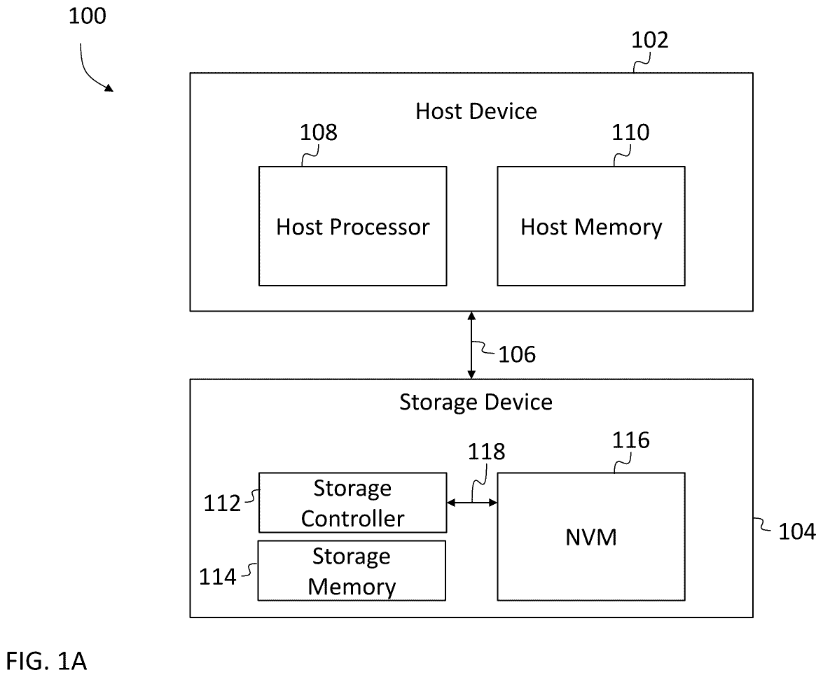

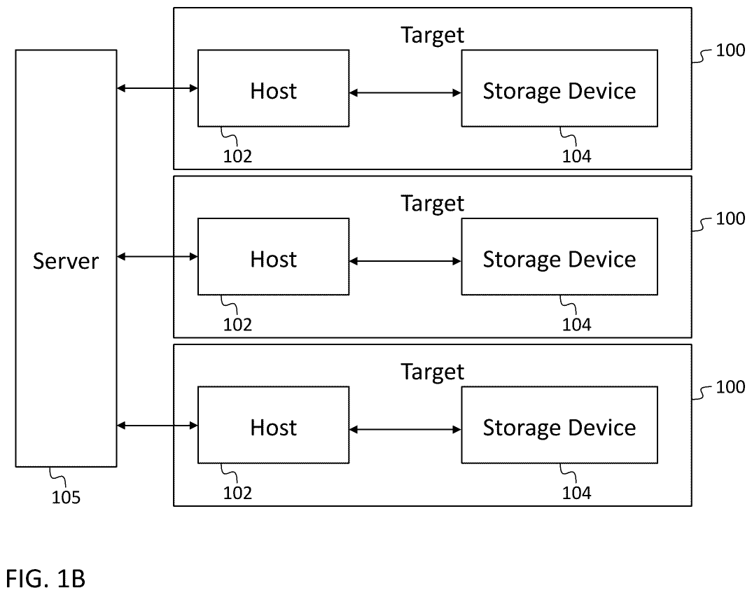

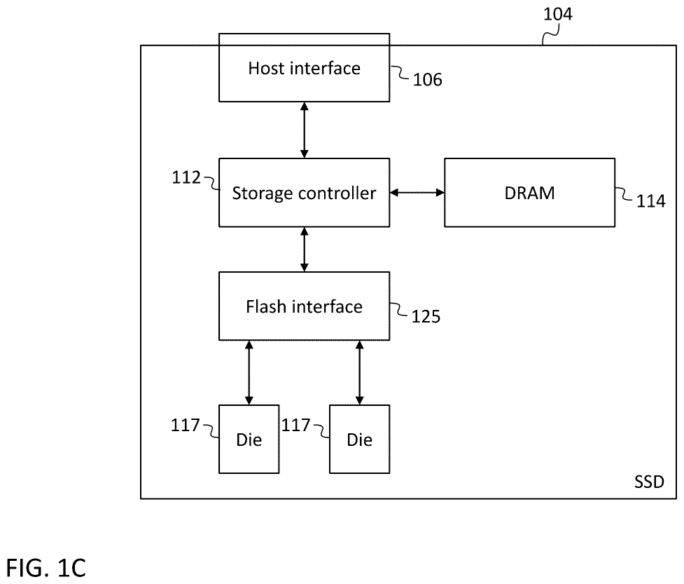

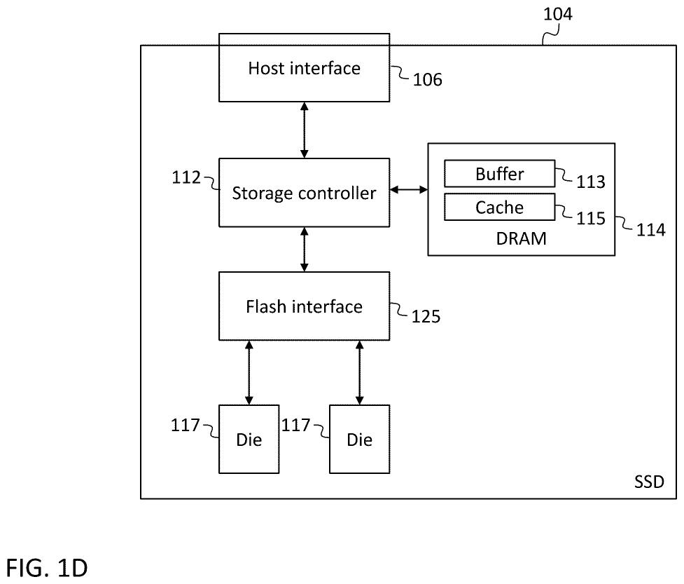

FIG. 1A illustrates a system, which may be referred to as a “target” 100, according to some embodiments of the present disclosure. Referring to FIG. 1A, the target 100 may include a host device 102 and a storage device 104 (which may be a persistent storage device 104). In some embodiments, the host device 102 may be housed with the storage device 104, and in other embodiments, the host device 102 may be separate from the storage device 104. The host device 102 may include any suitable computing device connected to a storage device 104 such as, for example, a personal computer (PC), a portable electronic device, a hand-held device, a laptop computer, or the like.

The host device 102 may be connected to the storage device 104 over a host interface 106. The host device 102 may issue data request commands or input-output (IO) commands (for example, read or write commands) to the storage device 104 over the host interface 106, and may receive responses from the storage device 104 over the host interface 106.

The host device 102 may include a host processor 108 and host memory 110. The host processor 108 may be a processing circuit (discussed in further detail below), for example, such as a general-purpose processor or a central processing unit (CPU) core of the host device 102. The host processor 108 may be connected to other components via an address bus, a control bus, a data bus, or the like. The host memory 110 may be considered as high performing main memory (for example, primary memory) of the host device 102. For example, in some embodiments, the host memory 110 may include (or may be) volatile memory, for example, such as dynamic random-access memory (DRAM). However, the present disclosure is not limited thereto, and the host memory 110 may include (or may be) any suitable high performing main memory (for example, primary memory) replacement for the host device 102 as would be known to those skilled in the art. For example, in other embodiments, the host memory 110 may be relatively high performing nonvolatile memory, such as NAND flash memory, Phase Change Memory (PCM), Resistive RAM, Spin-transfer Torque RAM (STTRAM), any suitable memory based on PCM technology, memristor technology, or resistive random access memory (ReRAM), and may include, for example, chalcogenides, or the like.

The storage device 104 may operate as secondary memory that may persistently store data accessible by the host device 102. In this context, the storage device 104 may include relatively slower memory when compared to the high performing memory of the host memory 110. For example, in some embodiments, the storage device 104 may be secondary memory of the host device 102, for example, such as a Solid-State Drive (SSD). However, the present disclosure is not limited thereto, and in other embodiments, the storage device 104 may include (or may be) any suitable storage device such as, for example, a magnetic storage device (for example, a hard disk drive (HDD), or the like), an optical storage device (for example, a Blue-ray disc drive, a compact disc (CD) drive, a digital versatile disc (DVD) drive, or the like), other kinds of flash memory devices (for example, a USB flash drive, and the like), or the like. In various embodiments, the storage device 104 may conform to a large form factor standard (for example, a 3.5-inch hard drive form-factor), a small form factor standard (for example, a 2.5 inch hard drive form-factor), an M.2 form factor, an E1.S form factor, or the like. In other embodiments, the storage device 104 may conform to any suitable or desired derivative of these form factors. For convenience, the storage device 104 may be described hereinafter in the context of a solid-state drive, but the present disclosure is not limited thereto.

The storage device 104 may be communicably connected to the host device 102 over the host interface 106. The host interface 106 may facilitate communications (for example, using a connector and a protocol) between the host device 102 and the storage device 104. In some embodiments, the host interface 106 may facilitate the exchange of storage requests (or “commands”) and responses (for example, command responses) between the host device 102 and the storage device 104. In some embodiments, the host interface 106 may facilitate data transfers by the storage device 104 to and from the host memory 110 of the host device 102. For example, in various embodiments, the host interface 106 (for example, the connector and the protocol thereof) may include (or may conform to) Small Computer System Interface (SCSI), Non Volatile Memory Express (NVMe), Peripheral Component Interconnect Express (PCIe), remote direct memory access (RDMA) over Ethernet, Serial Advanced Technology Attachment (SATA), Fiber Channel, Serial Attached SCSI (SAS), NVMe over Fabric (NVMe-oF), Peripheral Component Interconnect (PCI), Peripheral Component Interconnect Express (PCIe), Compute Express Link (CXL), or the like. In other embodiments, the host interface 106 (for example, the connector and the protocol thereof) may include (or may conform to) various general-purpose interfaces, for example, such as Ethernet, Universal Serial Bus (USB), and/or the like. In an embodiment in which the host interface 106 conforms to CXL, it may support the input-output CXL interface (CXL.io) or the memory interface (CXL.mem). The use of CXL.mem may make it possible to read data from the storage device 104 and to store data in the storage device 104 using microprocessor load and store instructions, respectively (e.g., without requiring a call to a driver function).

In some embodiments, the storage device 104 may include a storage controller 112, storage memory 114 (which may also be referred to as a buffer), nonvolatile memory (NVM) 116, and a storage interface 118. The storage memory 114 may be high-performing memory of the storage device 104, and may include (or may be) volatile memory, for example, such as DRAM, but the present disclosure is not limited thereto, and the storage memory 114 may be any suitable kind of high-performing volatile or nonvolatile memory. The nonvolatile memory 116 may persistently store data received, for example, from the host device 102. The nonvolatile memory 116 may include, for example, NAND flash memory, but the present disclosure is not limited thereto, and the nonvolatile memory 116 may include any suitable kind of memory for persistently storing the data according to an implementation of the storage device 104 (for example, magnetic disks, tape, optical disks, or the like).

The storage controller 112 may be connected to the nonvolatile memory 116 over the storage interface 118. In the context of the SSD, the storage interface 118 may be referred to as flash channel, and may be an interface with which the nonvolatile memory 116 (for example, NAND flash memory) may communicate with a processing component (for example, the storage controller 112) or other device. Commands such as reset, write enable, control signals, clock signals, or the like may be transmitted over the storage interface 118. Further, a software interface may be used in combination with a hardware element that may be used to test or verify the workings of the storage interface 118. The software may be used to read data from and write data to the nonvolatile memory 116 via the storage interface 118. Further, the software may include firmware that may be downloaded onto hardware elements (for example, for controlling write, erase, and read operations).

The storage controller 112 (which may be a processing circuit (discussed in further detail below)) may be connected to the host interface 106, and may manage signaling over the host interface 106. In some embodiments, the storage controller 112 may include an associated software layer (for example, a host interface layer) to manage the physical connector of the host interface 106. The storage controller 112 may respond to input or output requests received from the host device 102 over the host interface 106. The storage controller 112 may also manage the storage interface 118 to control, and to provide access to and from, the nonvolatile memory 116. For example, the storage controller 112 may include at least one processing component embedded therein for interfacing with the host device 102 and the nonvolatile memory 116. The processing component may include, for example, a general purpose digital circuit (for example, a microcontroller, a microprocessor, a digital signal processor, or a logic device (for example, a field programmable gate array (FPGA), an application-specific integrated circuit (ASIC), or the like)) capable of executing data access instructions (for example, via firmware or software) to provide access to the data stored in the nonvolatile memory 116 according to the data access instructions. For example, the data access instructions may correspond to the data request commands, and may include any suitable data storage and retrieval algorithm (for example, read, write, or erase) instructions, or the like.

FIG. 1B is a system-level diagram, in some embodiments. Within each target 100, a host 102 is connected to a persistent storage device 104 (which may be, for example, a solid-state drive (SSD)). The persistent storage device 104 may have (as discussed above) a form factor that is any one of a plurality of form factors suitable for persistent storage devices, including but not limited to 2.5″, 1.8″, MO-297, MO-300, M.2, and Enterprise and Data Center SSD Form Factor (EDSFF), and it may have an electrical interface (which may be referred to as a “host interface”), through which it may be connected to the host 102, that is any one of a plurality of interfaces suitable for persistent storage devices, including Peripheral Component Interconnect (PCI), PCI express (PCIe), Ethernet, Small Computer System Interface (SCSI), Serial AT Attachment (SATA), and Serial Attached SCSI (SAS) or Universal Flash Storage (UFS). The persistent storage device 104 may include an interface circuit which operates as an interface adapter between the host interface 106 and one or more internal interfaces in the persistent storage device 104.

The host interface may be used by the host 102 to communicate with the persistent storage device 104, for example, by sending write and read commands, which may be received, by the persistent storage device 104, through the host interface. The host interface may also be used by the persistent storage device 104 to perform data transfers to and from system memory of the host 102.

Such data transfers may be performed using direct memory access (DMA). For example, when the host 102 sends a write command to the persistent storage device 104, the persistent storage device 104 may fetch the data to be written to the nonvolatile memory 116 from the host memory 110 of the host device 102 using direct memory access, and the persistent storage device 104 may then save the fetched data to the nonvolatile memory 116. Similarly, if the host 102 sends a read command to the persistent storage device 104, the persistent storage device 104 may read the requested data (i.e., the data specified in the read command) from the nonvolatile memory 116 and save it in the host memory 110 of the host device 102 using direct memory access. The persistent storage device 104 may store data in a persistent memory, for example, not-AND (NAND) flash memory, for example, in memory dies containing memory cells, each of which may be, for example, a Single-Level Cell (SLC), a Multi-Level Cell (MLC), or a Triple-Level Cell (TLC).

A Flash Translation Layer (FTL) (discussed in further detail below) of the persistent storage device 104 may provide a mapping between logical addresses used by the host 102 and physical addresses of the data in the persistent memory. The persistent storage device 104 may also include (i) a buffer which may include (for example, consist of) dynamic random-access memory (DRAM), and (ii) a persistent memory controller (for example, a flash controller) for providing suitable signals to the persistent memory. Some or all of the host interface, the Flash Translation Layer, the buffer, and the persistent memory controller may be implemented in a processing circuit, which may be referred to as the persistent storage device controller.

FIG. 1C is a block diagram of a persistent storage device 104 (for example, a solid-state drive), in some embodiments. The host interface 106 is used by the host 102, to communicate with the persistent storage device 104. The data write and read input output commands, as well as various media management commands such as the Nonvolatile Memory Express (NVMe) Identify command and the NVMe Get Log command may be received, by the persistent storage device 104, through the host interface 106. The host interface 106 may also be used by the persistent storage device 104 to perform data transfers to and from host system memory. The persistent storage device 104 may store data in nonvolatile memory 116 (for example, not-AND (NAND) flash memory), for example, in memory dies 117 containing memory cells, each of which may be (as discussed above), for example, a Single-Level Cell (SLC), a Multi-Level Cell (MLC), or a Triple-Level Cell (TLC). A Flash Translation Layer (FTL), which may be implemented in the storage controller 112 (for example, based on firmware (for example, based on firmware stored in the nonvolatile memory 116) may provide a mapping between logical addresses used by the host and physical addresses of the data in the nonvolatile memory 116. The persistent storage device 104 may also include (i) a buffer (for example, the storage memory 114) (which may include, for example, consist of, dynamic random-access memory (DRAM)), and (ii) a flash interface (or “flash controller”) 125 for providing suitable signals to the memory dies 117 of the nonvolatile memory 116. Some or all of the host interface 106, the Flash Translation Layer (as mentioned above), the storage memory 114 (for example, the buffer), and the flash interface 125 may be implemented in a processing circuit, which may be referred to as the persistent storage device controller 112 (or simply as the storage controller 112).

The NAND flash memory may be read or written at the granularity of a flash page, which may be between 8 KB and 16 KB in size. Before the flash memory page is reprogrammed with new data, it may first be erased. The granularity of an erase operation may be one NAND block, or “physical block”, which may include, for example, between 128 and 256 pages. Because the granularity of erase and program operations are different, garbage collection (GC) may be used to free up partially invalid physical blocks and to make room for new data. The garbage collection operation may (i) identify fragmented flash blocks, in which a large proportion (for example, most) of the pages are invalid, and (ii) erase each such physical block. When garbage collection is completed, the pages in an erased physical block may be recycled and added to a free list in the Flash Translation Layer.

The nonvolatile memory 116 (for example, if it includes or is flash memory) may be capable of being programmed and erased only a limited number of times. This may be referred to as the maximum number of program/erase cycles (P/E cycles) the nonvolatile memory 116 can sustain. To maximize the life of the persistent storage device 104, the persistent storage device controller 112 may endeavor to distribute write operations across all of the physical blocks of the nonvolatile memory 116; this process may be referred to as wear leveling.

A mechanism that may be referred to as “read disturb” may reduce persistent storage device 104 reliability. A read operation on a NAND flash memory cell may cause the threshold voltage of nearby unread flash cells in the same physical block to change. Such disturbances may change the logical states of the unread cells, and may lead to uncorrectable error-correcting code (ECC) read errors, degrading flash endurance. To avoid this result, the Flash Translation Layer may have a counter of the total number of reads to a physical block since the last erase operation. The contents of the physical block may be copied to a new physical block, and the physical block may be recycled, when the counter exceeds a threshold (for example, 50,000 reads for Multi-Level Cell), to avoid irrecoverable read disturb errors. As an alternative, in some embodiments, a test read may periodically be performed within the physical block to check the error-correcting code error rate; if the error rate is close to the error-correcting code capability, the data may be copied to a new physical block.

FIG. 1D is a block diagram of a persistent storage device 104 (for example, a solid-state drive), in some embodiments, the storage device 104 includes a buffer 113 and a cache 115. As mentioned above, the buffer 113 may be used, e.g., as a queue, to store write commands pending command completion, making it possible for the storage device to accept additional commands before a write command has been completed. The cache 115 may be used to store data that the host may be expected to access again. As such, the cache 115 may make it possible (i) for data to be read repeatedly from the storage device without the data being read repeatedly from the nonvolatile memory, and (ii) for data to be modified in the cache 115 (without necessarily also being modified in the nonvolatile memory).

As mentioned above, in operation, a situation that may be referred to as “cache pollution” may occur when an application running on the host device 102, anticipating a need for a first data unit sends, to the storage device 104, a first user demand prefetch, which may be a command, to the storage device 104, to read the first data unit into the cache 115. As used herein, a “data unit” is a quantity of data, e.g., the data stored in a specified range of addresses, of the data associated with a specific layer of a neural network, or the data that is the subject of a user demand prefetch command. When the application sends, to the storage device 104, the first user demand prefetch, if the first data unit is already in the cache 115 (having previously been read from the nonvolatile memory 116 into the cache 115), the host device 102 may not act on the first user demand prefetch command.

For example, the cache controller may receive the user demand prefetch command, determine that the first data unit is already in the cache 115, and, therefore, not read the first data unit from the nonvolatile memory. The application may then, before having read the first data unit from the cache 115, issue a second user demand prefetch for a second data unit, which will be needed, by the application, after it has processed the first data unit. In response to the second user demand prefetch, the storage device may (i) determine that the cache 115 is full and that a cache eviction is needed to make room for the second data unit, (ii) determine that the first data unit (which may be older than other data units in the cache 115) is the best candidate for eviction, and evict the first data unit, and (iii) read the second data unit into the cache 115. As used herein, a data unit may be in a “cached state” or in a “backed state”. A data unit that is in a backed state is stored in the nonvolatile memory 116 which operates as a backing store (and not in the cache 115), and a data unit that is in the cached state is stored in the cache 115 (and may or may not also be stored in the nonvolatile memory 116), As such, the state of a data unit may be changed from backed to cached by reading the data unit from the nonvolatile memory 116 into the cache 115 (e.g., as a result of executing a user demand prefetch), and the state of a data unit may be changed from cached to backed by evicting the data unit from the cache 115 (and, e.g., updating the copy of the data unit in the nonvolatile memory 116 if the cached copy has been modified).

This sequence may result in the first data unit not being available in the cache 115 when subsequently needed by the application. As a result, the first data unit may be read into the cache 115 again, from the nonvolatile memory; this additional read operation may degrade the performance and power efficiency of the storage device. As such, in some embodiments, a first signal may be sent, by the application, to the storage device, indicating that the data unit is not to be evicted from the cache 115 (e.g., the state of the data unit is not to be changed from cached to backed) until a corresponding second signal (indicating that the data may be evicted) has been received by the storage device. In the illustrated implementations or embodiments, the first and second signals may be referred to as a “pin” command and an “unpin” command, but other terms may be used to describe it. For example the sending of the first signal may be referred to as a command to “place a lock” on the data unit and the sending of the second signal may be referred to as the sending of a command to release the lock on the data unit. As used herein, a data unit may be said to be “locked” if a lock has been placed on it and not subsequently released. In such an embodiment, when the application sends, to the storage device, a prefetch command for a data unit that will be needed, by the application, for a future calculation, it may also send a pin command to the storage device, to prevent the cached first data unit from being evicted before it has been used by the application.

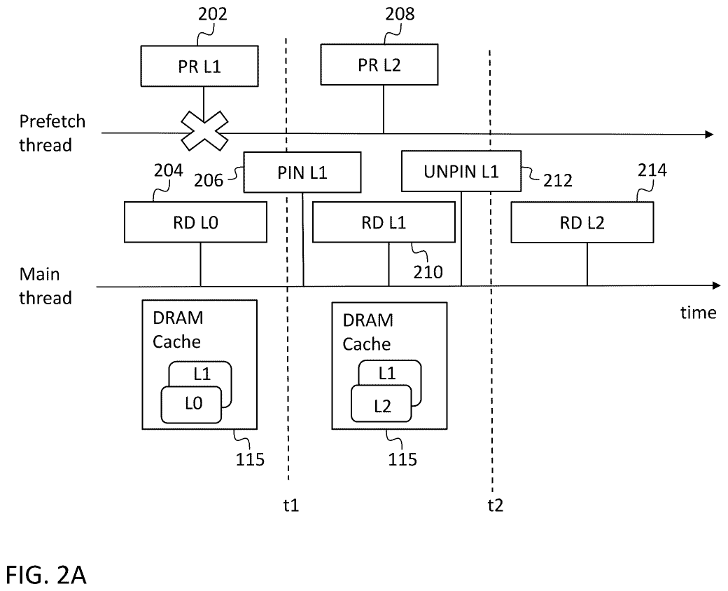

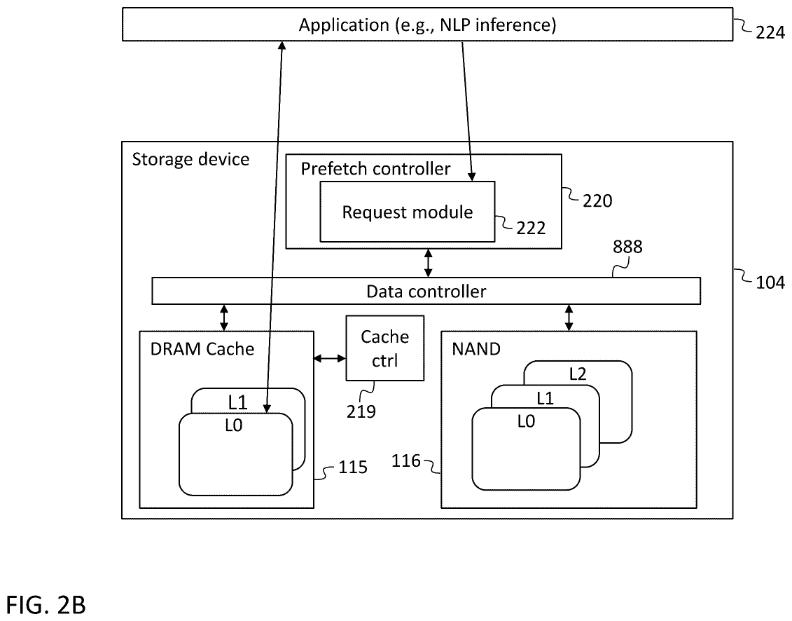

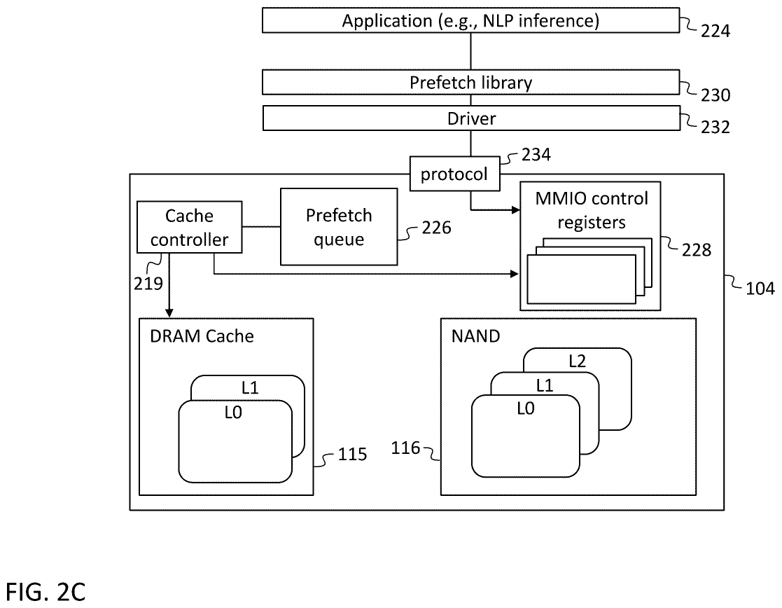

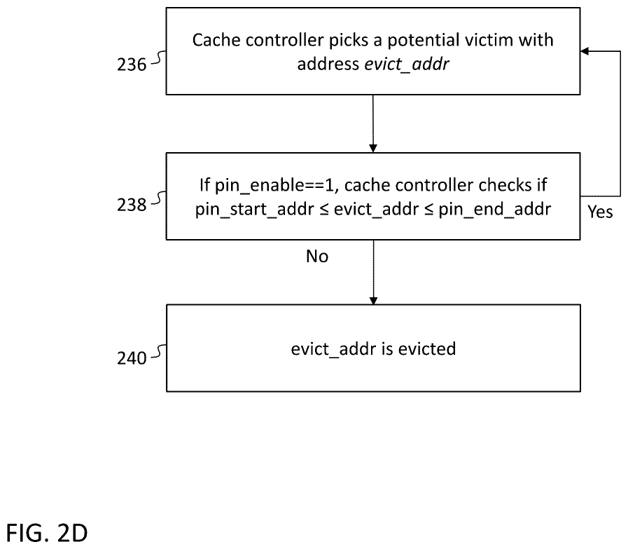

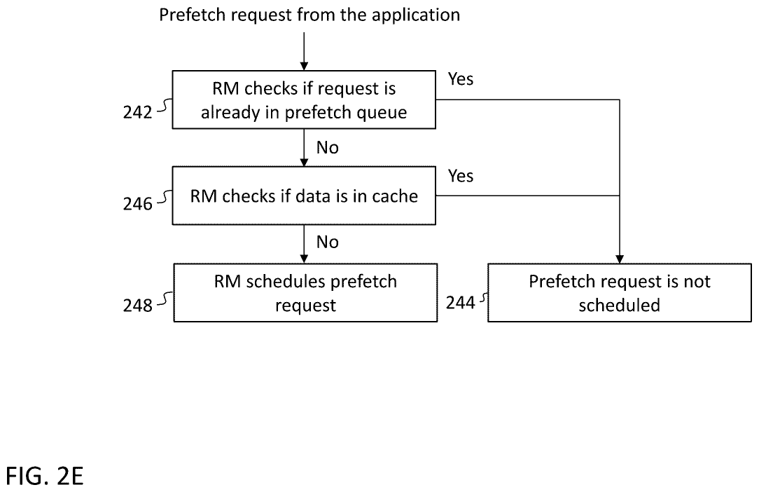

FIG. 2A shows an example of a sequence of operations, in some embodiments. Two threads, a prefetch thread and a main thread, run as part of an application running on the host device 102. At the beginning of the example, before time t1, the cache 115 contains two data units, L0 and L1. L0 and L1 (and L2, mentioned below) may be, for example, data corresponding to respective layers in a neural network, and the computing system may be configured to (e.g., it may be running an application to) perform neural network inference operations. The storage device 104 may receive a user demand prefetch 202 for the data unit L1 (labeled “PR L1”) and a read request 204, for the data unit L0. As shown, in the example the request module (discussed in further detail below) does not schedule the user demand prefetch 202 for L1 (as indicated by the “X” in FIG. 2A) because L1 is already in the cache 115.

After t1, the storage device 104 receives a pin command 206, from the prefetch thread, for data unit L1. This pin command causes the storage device 104 to (i) keep the pinned data unit L1 in the cache 115, and to not evict the pinned data unit L1 (e.g., not to change the state of the pinned data unit L1 from cached to backed) as long as sufficient unpinned data is available to satisfy any eviction requests (and, in some embodiments, to not evict the pinned data unit L1 even if sufficient unpinned data is not available to satisfy an eviction request). The storage device 104 further receives a user demand prefetch command 208, from the prefetch thread, for data unit L2 and a read command 210, from the main thread, for data unit L1. The user demand prefetch command 208, from the prefetch thread, for data unit L2, when executed, may cause the storage device 104 to determine that the cache 115 does not have sufficient free space for data unit L2, and, accordingly, determine that a cache eviction is needed to create free space for data unit L2. In some embodiments, the pin command for a data unit may be performed before the prefetch command for the data unit, to reduce the risk that the data unit may be evicted after the prefetch command is executed and before the pin command is executed.

If data unit L1 were not protected as a result of having been pinned by the pin command 206, it would be subject to eviction, e.g., if it is older than data unit L0. As used herein, when referring to data units in the cache 115, if a first data unit is described as “older” (or “lower priority”) than a second data unit, it means that the first data unit is earlier in line, for eviction, than the second data unit (e.g., the first data unit has lower priority for remaining in the cache 115 than the second data unit), and if a first data unit is described as “newer” (or “higher priority”) than a second data unit, it means that the first data unit is later in line, for eviction, than the second data unit (e.g., the first data unit has higher priority for remaining in the cache 115 than the second data unit). The position in line for eviction may be determined based on any one of, or any combination of, various cache eviction policies, including least recently used, least frequently used, and first in first out. Because, in the example of FIG. 2A, data unit L1 is protected as a result of having been pinned by the pin command 206, data unit L0 is evicted instead, and after the eviction of L0 and the performing of the user demand prefetch command 208 for data unit L2 (which, when performed, changes the state of data unit L2 from backed to cached), the cache 115 contains data unit L1 and data unit L2 as shown. The presence in the cache 115 of data unit L1 allows the read command 210 for data unit L1 to be executed without accessing the nonvolatile memory 116. Once the read command 210 for data unit L1 is executed, the prefetch thread may issue an unpin command 212, making it possible for data unit L1 to be evicted. After t2, operation may continue, with, e.g., the execution of a read command 214 for data unit L2.

FIG. 2B shows a storage device 104 including a cache 115, a nonvolatile memory 116, a cache controller 219, and a prefetch controller 220 including a request module 222. FIG. 2B also shows an application 224 that may run on the host device 102 and that may interact with the storage device 104. In the embodiment of FIG. 2B, the storage device 104 includes a prefetch controller 220 and a cache controller 219. Each of the cache controller 219 and the prefetch controller 220 (including a request module 222) may be implemented in firmware running in the storage controller, or either or both of these two entities may be implemented in dedicated or special-purpose hardware (e.g., a special-purpose or dedicated processing circuit). The prefetch controller 220 may not monitor the contents of the cache 115, and, as such, in the absence of a request module 222, the prefetch controller 220 may simply forward user demand prefetch commands to the cache controller 219 for processing. This may consume internal bandwidth in the storage device 104, as mentioned above. In some embodiments, the request module 222 is present and may process each user demand prefetch command for a data unit only when the command is not redundant, e.g., only when (i) a user demand prefetch command for the same data unit is not already in the prefetch queue 226 (FIG. 2C) and (ii) the data unit is not already in the cache 115.

FIG. 2C shows a storage device 104 including a cache 115, a nonvolatile memory 116, a cache controller 219, a prefetch queue 226, and a set of memory mapped input output (MMIO) control registers 228. FIG. 2C also shows an application 224 that may run on the host device 102 and that may interact with the storage device 104 through a prefetch library 230 (which may be library of functions for, e.g., sending a user demand prefetch, a pin command, or an unpin command) and a driver 232, for transmitting commands and receiving responses over a suitable protocol 234 (e.g., Compute Express Link input-output (CXL.io)).

The memory mapped input output control registers 228 may include a plurality of register sets, each register set including a set of three registers configured to store pinning information for one data unit (which may be specified as a range of addresses). For example, each set may include (i) a pin enable register (which may be referred to as pin_enable), which may be a Boolean value specifying whether the register set is active (e.g., whether the set currently corresponds to a pinned address range), and (ii) a start address register and an end address register which, when the pin enable register is set, specify the start and end of an address range of a data unit to which the register set is assigned. When the storage device 104 receives a pin command (which may include, as arguments, a start address and an end address), it identifies an inactive register set (e.g., a register set in which the pin enable register is unset), stores the start address and the end address in the start address register and the end address register, respectively, and sets the pin enable register to a value indicating that the set is active.

When the storage device 104 (e.g., the prefetch controller 220 of the storage device 104) determines that a cache eviction is needed, it may select a potential eviction victim from among the data units stored in the cache 115 (e.g., based on an eviction policy (e.g., a based on any one of, or any combination of, various cache eviction policies, including least recently used, least frequently used, or first in first out)) and, before performing the eviction, check the memory mapped input output control registers 228 to determine whether the potential eviction victim is pinned. If the potential eviction victim is pinned, the storage device 104 may continue to select, and check against the memory mapped input output control registers 228, additional potential eviction victims until it finds one that is not pinned. If no potential eviction victim is found that is not pinned, the storage device 104 may (i) not perform the eviction, or (ii) evict the oldest potential eviction victim, in spite of its being pinned.

FIG. 2D is a flowchart of this eviction process. At 236, the cache controller selects a potential eviction victim having a first address (which may be referred to as evict_addr); at 238, the cache controller determines whether the range of addresses occupied by the potential eviction victim overlaps with (e.g., partially or entirely overlaps with) the address range of any active register set in the memory mapped input output control registers 228 (e.g., for each register set in the memory mapped input output control registers 228 for which the pin_enable indicates that the register set is active, it determines whether evict_addr is between the start address (which may be referred to as pin_start_addr) and the end address (which may be referred to as pin_end_addr)). If it does overlap, then control returns to step 236, and the cache controller repeats the process after selecting a new potential eviction victim; if it does not overlap, then at 240, the potential eviction victim is evicted.

FIG. 2E is a flowchart of a method performed by the request module 222, in some embodiments. At 242, after receiving a request from the application, the request module 222 (“RM”) checks whether the request is already in the prefetch queue 226; if not, the request module 222 checks, at 246, whether the requested data unit is already in the cache 115. If the requested data unit is neither in the prefetch queue 226 nor in the cache 115, then, at 248, the request module 222 schedules a prefetch request (e.g., by placing the request in the prefetch queue 226. If the requested data unit is either in the prefetch queue 226 or in the cache 115, then, at 244, the prefetch request is not scheduled.

In some embodiments, as discussed above, the storage device 104 may schedule the performing of user demand prefetches based on information, e.g., a cache access sequence, that it has received from the application. The cache access sequence may include a sequence of cache access instructions (which may also be referred to as memory operations), including instructions such as, e.g., read, write, prefetch, pin, and unpin. The storage device 104 may use the cache access sequence to determine when to perform various operations, so as to make effective use of the cache 115. For example, if the sequence includes a prefetch command for a first data unit, followed by commands for other data units, followed by a pin command for the first data unit, the storage device 104 may delay the performing of the prefetch of the first data unit until just before or just after the pin command for the first data unit. The delaying of the prefetch of the first data unit until just before or just after the pin command for the first data unit may allow other data to remain in the cache 115 longer, and thereby reduce the risk of a cache miss. The delaying of the prefetch of the first data unit until just before or just after the pin command for the first data unit may also allow the storage device 104 to perform the intervening instructions sooner, which may result in an improvement in system performance.

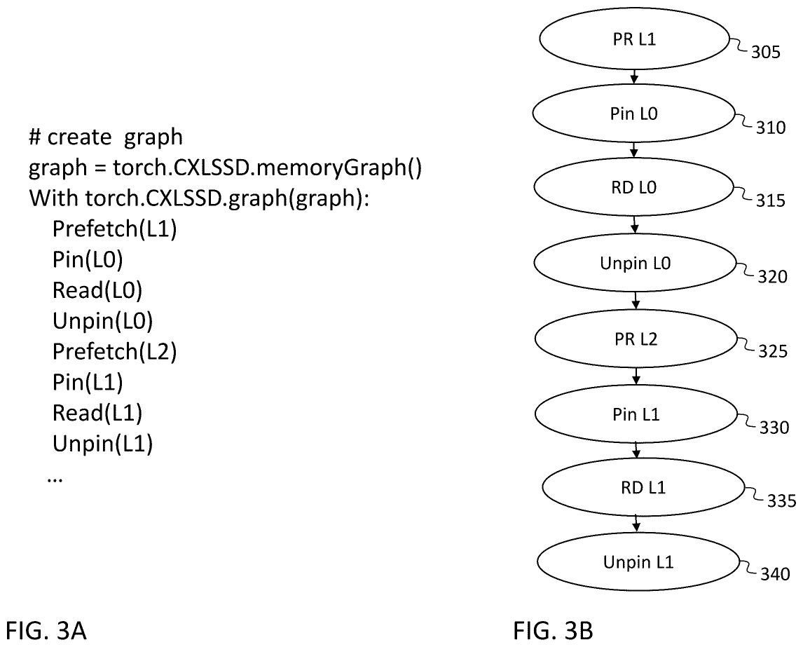

In some embodiments, the cache access sequence is generated in an automated manner, e.g., using a tool that may be used to generate deep learning models, such as PyTorch. Such a tool may be capable of generating a memory graph (e.g., using the memoryGraph( ) function of PyTorch), which may include nodes each of which is a memory operation (such as read, store, prefetch, pin, and unpin). The table of FIG. 3A shows a sequence of instructions including a set of cache access instructions, and FIG. 3B shows the corresponding memory graph that may be generated from this cache access sequence. In the example of FIGS. 3A and 3B, the cache access sequence includes a prefetch (PR) 305 of data unit L1, a pin 310 of data unit L0, a read (RD) 315 of data unit L0, an unpin 320 of data unit L0, a prefetch 325 of data unit L2, a pin 330 of data unit L1, a read 335 of data unit L1, and an unpin 340 of data unit L1. In this example, the storage device 104 may delay the prefetch 305 of data unit L1 until just before the pin 330 of data unit L1. In FIG. 3A, “CXLSSD” is an abbreviation for “Compute Express Link solid state drive”.

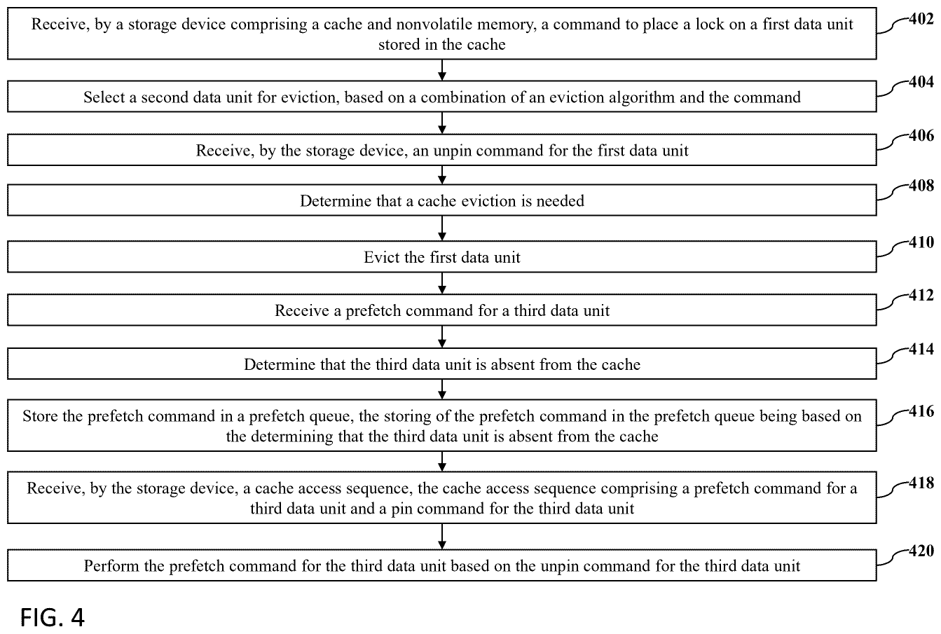

FIG. 4 shows a method of operating a storage device, in some embodiments. Although FIG. 4 illustrates various operations in a method of operating a storage device, embodiments according to the present disclosure are not limited thereto. For example, according to some embodiments, a method of operating a storage device may include addition operations or fewer operations, or the order of operations may vary (unless otherwise explicitly stated or implied) without departing from the spirit and scope of embodiments according to the present disclosure.

The method includes receiving, at 402, by a storage device comprising a cache and nonvolatile memory, a command (e.g., a pin command) to place a lock on a first data unit stored in the cache. For example, as discussed above in the context of FIG. 2A, the pin command may pin a first data unit L1, which may be older than a second data unit L0. As discussed above in the context of FIG. 2A, an eviction may be needed to perform a user demand prefetch, such as, in FIG. 2A, the user demand prefetch command requesting a prefetch of the data unit L2. The method further includes selecting, at 404, a second data unit for eviction, based on a combination of an eviction algorithm and the command. The eviction algorithm may involve applying any one of, or any combination of, various cache eviction policies mentioned herein, and taking into account whether any data unit that is otherwise a candidate for eviction is pinned. For example, as discussed above in the context of FIG. 2A, because the first data unit L1 is pinned, the second data unit L0 may be evicted even if it is newer than the first data unit L1. In some embodiments, the selecting of the second data unit for eviction includes performing a first iteration of the eviction algorithm, the first iteration selecting the first data unit; and based on the command (e.g., based on determining that the first data unit is pinned), performing a second iteration of the eviction algorithm, the second iteration selecting the second data unit for eviction. In some embodiments, the selecting of the second data unit for eviction includes selecting, by the eviction algorithm, the second data unit from a set of data units determined based on the command (e.g., candidates for eviction may first be selected from a set of unpinned data units, and the eviction algorithm may be used to select a data unit for eviction from this set of candidates). For example, in some embodiments, the first data unit is excluded from the set of data units based on the command (e.g., based on the determining that the first data unit is pinned). In some embodiments, the eviction algorithm targets a data unit characteristic (e.g., the algorithm may use a least recently used eviction policy, in which case the characteristic may be recency of usage), the first data unit has a first value of the data unit characteristic, the second data unit has a second value of the data unit characteristic, the algorithm is configured to select the first data unit based on the first value and the second value, and the second data unit is selected for eviction based on the command. In some embodiments, the data unit characteristic is based on recency of usage.

In some embodiments, the method further includes receiving, at 406, by the storage device, an unpin command for the first data unit; determining, at 408, that a cache eviction is needed; and evicting, at 410, the first data unit. For example, as discussed above in the context of FIG. 2A, once the data unit L1 has been read, from the cache, by the application, it may be unpinned. It may then be evicted, once it is determined that a cache eviction is needed. In some embodiments, the pin command includes a first argument specifying an address, and a second argument specifying a size.

In some embodiments, the method further includes receiving, at 412, a prefetch command for a third data unit; determining, at 414, that the third data unit is absent from the cache; and storing, at 416, the prefetch command in a prefetch queue, the storing of the prefetch command in the prefetch queue being based on the determining that the third data unit is absent from the cache 115. For example, as discussed above in the context of FIG. 2E, if the data unit is absent from the cache 115, and the prefetch request is absent from the prefetch queue 226, then the request module 222 may store prefetch request in the prefetch queue (based on (e.g., based in part on) the determining that the third data unit is not in the cache 115).

In some embodiments, the storing of the prefetch command in the prefetch queue is further based on determining that a prefetch command for the third data unit is absent from the prefetch queue.

In some embodiments, the method further includes receiving, at 418, by the storage device, a cache access sequence, the cache access sequence including a prefetch command for a third data unit and a pin command for the third data unit. For example, as discussed above with respect to FIGS. 3A and 3B, the cache access sequence may include a prefetch command for the data unit L1 and a pin command for the data unit L1. In some embodiments, the method further includes performing, at 420, the prefetch command for the third data unit based on the pin command for the third data unit. For example, discussed above with respect to FIGS. 3A and 3B, the cache access sequence may include the prefetch 305 of data unit L1, which the storage device 104 may perform based on (e.g., delayed until just before or just after) the pin 330 of data unit L1.

As used herein, “a portion of” something means “at least some of” the thing, and as such may mean less than all of, or all of, the thing. As such, “a portion of” a thing includes the entire thing as a special case, i.e., the entire thing is an example of a portion of the thing. As used herein, when a second quantity is “within Y” of a first quantity X, it means that the second quantity is at least X-Y and the second quantity is at most X+Y. As used herein, when a second number is “within Y %” of a first number, it means that the second number is at least (1−Y/100) times the first number and the second number is at most (1+Y/100) times the first number. As used herein, the term “or” should be interpreted as “and/or”, such that, for example, “A or B” means any one of “A” or “B” or “A and B”.

The background provided in the Background section of the present disclosure section is included only to set context, and the content of this section is not admitted to be prior art. Any of the components or any combination of the components described (e.g., in any system diagrams included herein) may be used to perform one or more of the operations of any flow chart included herein. Further, (i) the operations are example operations, and may involve various additional steps not explicitly covered, and (ii) the temporal order of the operations may be varied.

Each of the terms “processing circuit” and “means for processing” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

As used herein, when a method (e.g., an adjustment) or a first quantity (e.g., a first variable) is referred to as being “based on” a second quantity (e.g., a second variable) it means that the second quantity is an input to the method or influences the first quantity, e.g., the second quantity may be an input (e.g., the only input, or one of several inputs) to a function that calculates the first quantity, or the first quantity may be equal to the second quantity, or the first quantity may be the same as (e.g., stored at the same location or locations in memory as) the second quantity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” or “between 1.0 and 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Similarly, a range described as “within 35% of 10” is intended to include all subranges between (and including) the recited minimum value of 6.5 (i.e., (1−35/100) times 10) and the recited maximum value of 13.5 (i.e., (1+35/100) times 10), that is, having a minimum value equal to or greater than 6.5 and a maximum value equal to or less than 13.5, such as, for example, 7.4 to 10.6. Any maximum numerical limitation recited herein is intended to include all lower numerical limitations subsumed therein and any minimum numerical limitation recited in this specification is intended to include all higher numerical limitations subsumed therein.

Some embodiments may include features of the following numbered statements.
1. A method, comprising:
receiving, by a storage device comprising a cache and nonvolatile memory, a command to place a lock on a first data unit stored in the cache; and
selecting a second data unit for eviction, based on a combination of an eviction algorithm and the command.
2. The method of statement 1, wherein the selecting of the second data unit for eviction comprises:
performing a first iteration of the eviction algorithm, the first iteration selecting the first data unit; and
based on the command, performing a second iteration of the eviction algorithm, the second iteration selecting the second data unit for eviction.
3. The method of statement 1 or statement 2, wherein the selecting of the second data unit for eviction comprises selecting, by the eviction algorithm, the second data unit from a set of data units determined based on the command.
4. The method of statement 3, wherein the first data unit is excluded from the set of data units based on the command.
5. The method of any one of the preceding statements, wherein:
the eviction algorithm targets a data unit characteristic,
the first data unit has a first value of the data unit characteristic,
the second data unit has a second value of the data unit characteristic,
the algorithm is configured to select the first data unit based on the first value and the second value, and
the second data unit is selected for eviction based on the command.
6. The method of statement 5, wherein the data unit characteristic is based on recency of usage.
7. The method of statement 5, wherein:
the eviction algorithm ranks a plurality of data units, including the first data unit and the second data unit, according to the data unit characteristic, and
the eviction algorithm selects the second data unit based on the second data unit being a highest-ranked data unit that is not locked.
8. The method of any one of the preceding statements, further comprising:
receiving, by the storage device, a command to release the lock on the first data unit;
determining that a cache eviction is needed; and
evicting the first data unit.
9. The method of any one of the preceding statements, further comprising:
receiving a prefetch command for a third data unit;
determining that the third data unit is absent from the cache; and
storing the prefetch command in a prefetch queue, the storing of the prefetch command in the prefetch queue being based on the determining that the third data unit is absent from the cache.
10. The method of statement 9, wherein the storing of the prefetch command in the prefetch queue is further based on determining that a prefetch command for the third data unit is absent from the prefetch queue.
11. The method of any one of the preceding statements, further comprising:
receiving, by the storage device, a cache access sequence, the cache access sequence comprising a prefetch command for a third data unit and a command to place a lock on the third data unit.
12. The method of statement 11, further comprising performing the prefetch command for the third data unit based on the command to place the lock on the third data unit.
13. A storage device, comprising:

nonvolatile memory;

a processing circuit; and
a cache,
the processing circuit being configured to
   receive a command to place a lock on a first data unit stored in the cache; and
   select a second data unit for eviction, based on a combination of an eviction algorithm and the command.
14. The storage device of statement 13, wherein the selecting of the second data unit for eviction comprises:
performing a first iteration of the eviction algorithm, the first iteration selecting the first data unit; and
based on the command, performing a second iteration of the eviction algorithm, the second iteration selecting the second data unit for eviction.
15. The storage device of statement 13 or statement 14, wherein the selecting of the second data unit for eviction comprises selecting, by the eviction algorithm, the second data unit from a set of data units determined based on the command.
16. The storage device of statement 15, wherein the first data unit is excluded from the set of data units based on the command.
17. The storage device of any one of statements 13 to 16, wherein:
the eviction algorithm targets a data unit characteristic,
the first data unit has a first value of the data unit characteristic,
the second data unit has a second value of the data unit characteristic,
the algorithm is configured to select the first data unit based on the first value and the second value, and
the second data unit is selected for eviction based on the command.
18. The storage device of statement 17, wherein:
the eviction algorithm ranks a plurality of data units, including the first data unit and the second data unit, according to the data unit characteristic, and
the eviction algorithm selects the second data unit based on the second data unit being a highest-ranked data unit that is not locked.
19. A storage device, comprising:
nonvolatile memory;
means for processing; and
a cache,
the means for processing being configured to
   receive a command to place a lock on a first data unit stored in the cache; and
   select a second data unit for eviction, based on a combination of an eviction algorithm and the command.
20. The storage device of statement 19, wherein the selecting of the second data unit for eviction comprises:
performing a first iteration of the eviction algorithm, the first iteration selecting the first data unit; and
based on the command, performing a second iteration of the eviction algorithm, the second iteration selecting the second data unit for eviction.

Although exemplary embodiments of a storage device with a cache have been specifically described and illustrated herein, many modifications and variations will be apparent to those skilled in the art. Accordingly, it is to be understood that a storage device with a cache constructed according to principles of this disclosure may be embodied other than as specifically described herein. The invention is also defined in the following claims, and equivalents thereof.

What is claimed is:

1. A method, comprising:
receiving, by a storage device comprising a cache and nonvolatile memory, a command to place a lock on a first data unit stored in the cache; and
selecting a second data unit for eviction, based on a combination of an eviction algorithm and the command.

2. The method of claim 1, wherein the selecting of the second data unit for eviction comprises:
performing a first iteration of the eviction algorithm, the first iteration selecting the first data unit; and
based on the command, performing a second iteration of the eviction algorithm, the second iteration selecting the second data unit for eviction.

3. The method of claim 1, wherein the selecting of the second data unit for eviction comprises selecting, by the eviction algorithm, the second data unit from a set of data units determined based on the command.

4. The method of claim 3, wherein the first data unit is excluded from the set of data units based on the command.

5. The method of claim 1, wherein:
the eviction algorithm targets a data unit characteristic,
the first data unit has a first value of the data unit characteristic,
the second data unit has a second value of the data unit characteristic,
the algorithm is configured to select the first data unit based on the first value and the second value, and
the second data unit is selected for eviction based on the command.

6. The method of claim 5, wherein the data unit characteristic is based on recency of usage.

7. The method of claim 5, wherein:
the eviction algorithm ranks a plurality of data units, including the first data unit and the second data unit, according to the data unit characteristic, and
the eviction algorithm selects the second data unit based on the second data unit being a highest-ranked data unit that is not locked.

8. The method of claim 1, further comprising:
receiving, by the storage device, a command to release the lock on the first data unit;
determining that a cache eviction is needed; and
evicting the first data unit.

9. The method of claim 1, further comprising:
receiving a prefetch command for a third data unit;
determining that the third data unit is absent from the cache; and
storing the prefetch command in a prefetch queue, the storing of the prefetch command in the prefetch queue being based on the determining that the third data unit is absent from the cache.

10. The method of claim 9, wherein the storing of the prefetch command in the prefetch queue is further based on determining that a prefetch command for the third data unit is absent from the prefetch queue.

11. The method of claim 1, further comprising:
receiving, by the storage device, a cache access sequence, the cache access sequence comprising a prefetch command for a third data unit and a command to place a lock on the third data unit.

12. The method of claim 11, further comprising performing the prefetch command for the third data unit based on the command to place the lock on the third data unit.

13. A storage device, comprising:
nonvolatile memory;
a processing circuit; and
a cache,
the processing circuit being configured to
receive a command to place a lock on a first data unit stored in the cache; and
select a second data unit for eviction, based on a combination of an eviction algorithm and the command.

14. The storage device of claim 13, wherein the selecting of the second data unit for eviction comprises:
performing a first iteration of the eviction algorithm, the first iteration selecting the first data unit; and
based on the command, performing a second iteration of the eviction algorithm, the second iteration selecting the second data unit for eviction.

15. The storage device of claim 13, wherein the selecting of the second data unit for eviction comprises selecting, by the eviction algorithm, the second data unit from a set of data units determined based on the command.

16. The storage device of claim 15, wherein the first data unit is excluded from the set of data units based on the command.

17. The storage device of claim 13, wherein:
the eviction algorithm targets a data unit characteristic,
the first data unit has a first value of the data unit characteristic,
the second data unit has a second value of the data unit characteristic,
the algorithm is configured to select the first data unit based on the first value and the second value, and
the second data unit is selected for eviction based on the command.

18. The storage device of claim 17, wherein:
the eviction algorithm ranks a plurality of data units, including the first data unit and the second data unit, according to the data unit characteristic, and
the eviction algorithm selects the second data unit based on the second data unit being a highest-ranked data unit that is not locked.

19. A storage device, comprising:
nonvolatile memory;
means for processing; and
a cache,
the means for processing being configured to
receive a command to place a lock on a first data unit stored in the cache; and
select a second data unit for eviction, based on a combination of an eviction algorithm and the command.

20. The storage device of claim 19, wherein the selecting of the second data unit for eviction comprises:
performing a first iteration of the eviction algorithm, the first iteration selecting the first data unit; and
based on the command, performing a second iteration of the eviction algorithm, the second iteration selecting the second data unit for eviction.
